(19) United States
(12) Patent Application Publication
(10) Pub. No.: US 2025/0357672 A1
(43) Pub. Date: Nov. 20, 2025

(54) MILLIMETER-WAVE WIDEBEAM DIELECTRIC RESONATOR ANTENNA, DESIGN METHOD THEREFOR, WIDE-ANGLE BEAM-SCANNING PHASED ARRAY, AND DESIGN METHOD THEREFOR

(71) Applicant: SOUTH CHINA UNIVERSITY OF TECHNOLOGY, Guangzhou (CN)

(72) Inventors: Yongmei Pan, Guangzhou (CN); Zhiming Xiao, Guangzhou (CN); Qixuan Lai, Guangzhou (CN)

(21) Appl. No.: 19/280,090

(22) Filed: Jul. 24, 2025

Related U.S. Application Data
(63) Continuation of application No. PCT/CN2023/109919, filed on Jul. 28, 2023.

(30) Foreign Application Priority Data
May 5, 2023 (CN) 202310499995.X

(51) Int. Cl. H01Q 9/04; H01Q 3/24

(52) U.S. Cl. CPC H01Q 9/0485; H01Q 3/242

(57) ABSTRACT

Disclosed are a millimeter-wave widebeam DRA and a design method therefor, and a wide-angle beam-scanning phased array and a design method therefor. The DRA is composed of a DR and a microstrip-coupled slot centrally located beneath the DR. According to this disclosure, by setting dimensions of the slot and the DR, the resonant frequency of an unexcitable DRA TE₁₁₂ mode matches the resonant frequency of the resonance frequency of the microstrip-coupled slot; and the field inside the DR presents a field distribution similar to that in the TE₁₁₂ mode to form an equivalent magnetic flow parallel to a ground plane, so that widebeam characteristics are achieved in an E-plane and an H-plane. Additionally, by arraying multiple such small-sized DRA units at equal intervals, a linear phased array is formed on the E-plane and H-plane. No parasitic structure and additional active control circuit are required.

### CROSS-REFERENCE TO RELATED APPLICATIONS

This application is a continuation application of Patent Cooperation Treaty Application No. PCT/CN2023/109919, filed on Jul. 28, 2023, which claims the benefit of Chinese Patent Application No. 202310499995.X filed on May 5, 2023, the content of which is incorporated herein by reference in its entirety.

### TECHNICAL FIELD

The disclosure generally relates to millimeter-wave (mm-wave) wireless communication, and more specifically to a millimeter-wave widebeam DRA (Dielectric Resonator Antenna), a wide-angle beam-scanning phased array, and design methods thereof.

### BACKGROUND

In millimeter-wave wireless communication systems, the propagation loss of electromagnetic waves is serious, which greatly restricts the transmission distance of signals. To mitigate this problem, high-gain phased arrays capable of wide-angle beam-scanning have been put forward as an efficient solution. Consequently, millimeter-wave antenna elements that have simple structure, small size, and wide beamwidth are widely desired.

Compared with metallic antennas, such as microstrip antenna and dipole antenna, the dielectric resonator antenna (DRA) features higher radiation efficiency because of the absence of conductor loss. Moreover, the DRA provides a higher degree of design freedom due to its 3-D structure and abundant operating modes and hence is drawing increasing interest in antenna field. Meanwhile, a number of effective approaches have been proposed to expand the beamwidth of DRA. For instance, based on the concept of complementary antenna, the widebeam DRAs in some approaches were designed by superimposing radiation fields of a magnetic dipole that was realized by a DRA mode and an electric dipole that was realized by a small ground plane or monopole, giving wide half-power beamwidths (HPBWs) of over 120° in both the E-plane and H-plane. Multiple operating modes of DRA with complementary patterns, including high-order modes (HOMs), were intentionally selected to generate a broad beam of about 200°, but at the cost of using relatively complex DRA structures such as step-shaped DRA and arc-shaped DRA. Even though the widebeam DRA in some approaches that combined the fundamental mode and adjacent higher order mode (HOM) had a simple structure, its radiation performance heavily depends on the size of ground plane, thereby limiting its application. Consequently, most of the above DRAs are not applicable for constructing wide-angle beam-scanning phased arrays due to their large footprint, irregular configuration, or specific ground.

Fortunately, the widebeam DRA elements based on the techniques of parasitic loading have been put forward, realizing wide-angle beam-scanning phased arrays with excellent performance. Specifically, by loading metal ring and dielectric slabs, the DRA element in some approaches achieved wide beamwidths of 172° in the E-plane and 149° in the H-plane. Its nine-element H-plane linear phased array could scan from −72° to +72° with a low gain fluctuation of 0.9 dB. However, this parasitic loading strategy forces the introduction of additional structures into the original DRA, thereby increasing the complexity of antenna element and array undesirably. In addition, the popular pattern reconfigurable technique was also successfully used in the design of DRA phased array. By controlling the phase difference between the fundamental TE and TM modes excited by two diverse ports, the DRA could reconfigure its E-plane pattern with two ±66° tilted beams. Based on this phase-controlled pattern reconfigurable DRA element, a passive four-element phased array was constructed, which showed a broad beam-scanning range of ±81°. Nevertheless, this four-element array involved eight ports and four additional phase shifters. Similarly, in other approaches, although the phased arrays constructed by pattern-reconfigurable DRA elements could also achieve great wide-angle beam-scanning performance, additional active control circuits were required to control beam direction, which makes the entire antenna system complicated, especially for a large-scale mm-wave phased array.

### SUMMARY

This disclosure provides a millimeter-wave widebeam DRA (Dielectric Resonator Antenna), a wide-angle beam-scanning phased array, a design method for a millimeter-wave widebeam DRA, and a design method for a wide-angle beam-scanning phased array, without requiring any additional parasitic structure(s) and active control circuit(s), while maintaining a compact size, aiming at a technical problem existing in a prior wide-angle beam-scanning phased array, such as a large footprint or a complex structure.

Technical solutions adopted by this disclosure to solve its technical problem is as follows.

According to a first aspect, a design method for a millimeter-wave widebeam dielectric resonator antenna is provided, wherein the dielectric resonator antenna is composed of a dielectric resonator and a microstrip-coupled slot which is centrally located beneath the dielectric resonator; wherein the method includes:
design step for initial dimension of the dielectric resonator: determining an initial dimension of the dielectric resonator, so as to make a resonance frequency of a TE₁₁₂ mode of the dielectric resonator match a given working frequency f₀;
design step for initial dimension of the microstrip-coupled slot: determining an initial dimension of the microstrip-coupled slot, so as to make a resonance frequency of the microstrip-coupled slot match the given working frequency f₀;
adjusting step for dimensions: adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna.

In a preferable embodiment, the design step for initial dimension of the dielectric resonator includes: designing the dielectric resonator to have a square cross-section, wherein an initial side length a and an initial height h of the dielectric resonator are both set as a=h=0.27λ₀, wherein λ₀ represents a free-space wavelength of electromagnetic wave at the given working frequency f₀.

In a preferable embodiment, the design step for initial dimension of the microstrip-coupled slot includes: designing, on a ground plane on a top of a dielectric substrate, the microstrip-coupled slot which is centrally located beneath the dielectric resonator; wherein an initial length lₛ of the microstrip-coupled slot is set as lₛ=0.5λ_{g1}, an initial width wₛ of the microstrip-coupled slot is set as wₛ=0.05λ_{g1}, wherein λ_{g 1}represents a guided wavelength of electromagnetic wave in the dielectric resonator at the given working frequency f₀.

In a preferable embodiment, the adjusting step for dimensions includes:
observing whether an electric field distribution inside the dielectric resonator presents a ring-shaped electric field distribution of a quasi-TE₁₁₂ mode;
determining that a resonance frequency of the TE₁₁₂ mode of the dielectric resonator antenna matches a resonance frequency of a slot mode, when the electric field distribution inside the dielectric resonator matches the ring-shaped electric field distribution of the quasi-TE₁₁₂ mode.

In a preferable embodiment, the method further includes: designing a stepped microstrip line at a bottom of the dielectric substrate;
the adjusting step for dimensions further includes:
adjusting a dimension of the stepped microstrip line for impedance matching.

According to a second aspect, a millimeter-wave widebeam dielectric resonator antenna is constructed and designed based on the aforementioned method.

According to a third aspect, a design method for a wide-angle beam-scanning phased array, including:
determining an initial dimension of the dielectric resonator, so as to make a resonance frequency of a TE₁₁₂ mode of the dielectric resonator match a given working frequency f₀;
determining an initial dimension of the microstrip-coupled slot, so as to make a resonance frequency of the microstrip-coupled slot match the given working frequency f₀;
adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining a millimeter-wave widebeam dielectric resonator antenna;

arraying a plurality of designed millimeter-wave widebeam dielectric resonator antennas at equal intervals in a straight line according to a preset spacing to form a linear phased array;
tuning the spacing between the designed millimeter-wave widebeam dielectric resonator antennas, the adjusted dimension of the dielectric resonator, and the adjusted dimension of the microstrip-coupled slot, so as to make the resonance frequency of the TE₁₁₂ mode of the dielectric resonator match the resonance frequency of the microstrip-coupled slot for obtaining the wide-angle beam-scanning phased array.

In a preferable embodiment, the preset spacing is 0.472, wherein λ₀ represents a free-space wavelength of electromagnetic wave at the given working frequency f₀.

In a preferable embodiment, the linear phased array is an H-plane linear phased array; a length direction of the microstrip-coupled slot is parallel to an arraying direction of the plurality of designed millimeter-wave widebeam dielectric resonator antennas; a microstrip line is l-shaped as a whole, and vertical to the microstrip-coupled slot; wherein the microstrip line extends from a side edge of a dielectric substrate along a projection of a perpendicular midline of the microstrip-coupled slot at a width w₁ for a length l₁, and then still extends along the projection of the perpendicular midline of the microstrip-coupled slot at a reduced width w₂ and beyond the projection of the perpendicular midline of the microstrip-coupled slot for a length l₂; wherein the side edge of the dielectric substrate is parallel to the microstrip-coupled slot.

In a preferable embodiment, the linear phased array is an E-plane linear phased array; a length direction of the microstrip-coupled slot is vertical to an arraying direction of the plurality of designed millimeter-wave widebeam dielectric resonator antennas; a microstrip line is 7-shaped as a whole; wherein the microstrip line deviates from the microstrip-coupled slot and extends from a side edge of a dielectric substrate along the length direction of the microstrip-coupled slot at a width w₁ for a length l₁, then still extends along the length direction of the microstrip-coupled slot at a reduced width w₂ to a projection of a perpendicular midline of the microstrip-coupled slot, and then turns for 90° to extend along the projection of the perpendicular midline of the microstrip-coupled slot at the reduced width w₂ and beyond the projection of the perpendicular midline of the microstrip-coupled slot for a length l₂; wherein the side edge of the dielectric substrate is vertical to the microstrip-coupled slot.

According to a fourth aspect, a wide-angle beam-scanning phased array is constructed and designed based on the aforementioned method.

The millimeter-wave widebeam DRA, wide-angle beam-scanning phased array, design method for a millimeter-wave widebeam DRA, and design method for a wide-angle beam-scanning phased array in this disclosure have following technical benefits. The millimeter-wave widebeam DRA in this disclosure is composed of a DR and a microstrip-coupled slot centrally located beneath the DR. In this disclosure, by arranging dimensions of the microstrip-coupled slot and the dielectric resonator to make the resonance frequency of the unexcitable TE₁₁₂ mode of the dielectric resonator match the resonance frequency of the microstrip-coupled slot, the DR shows a quasi-TE₁₁₂ mode field distribution in its interior, which radiates as an equivalent magnetic current parallel to the ground plane, thus realizing widebeam performance in E-plane and H-plane. Moreover, an E-plane and an H-plane linear phased array can be formed by arraying a plurality of designed millimeter-wave widebeam dielectric resonator antennas at equal intervals in a straight line according to a preset spacing, wherein the H-plane linear phased array shows a scan range of ±72° with 2.5-dB gain fluctuation and the E-plane linear phased array a scan range of ±65° with 0.5-dB gain fluctuation. Furthermore, the millimeter-wave widebeam DRA and wide-angle beam-scanning phased array of this disclosure requires not any additional parasitic structure(s) and active control circuit(s), thus having a compact dimension.

### BRIEF DESCRIPTION OF THE DRAWINGS

In order to provide a clearer explanation of the technical solution in the embodiments of this disclosure, a brief introduction is given to the accompanying drawings required in the description of the embodiments. It is evident that the accompanying drawings in the following description are only some embodiments of this disclosure. For ordinary technical personnel in the art, other accompanying drawings can be obtained based on these drawings without any creative effort.

FIG. 1 shows a perspective view of a millimeter-wave widebeam DRA in an embodiment of this disclosure.

FIG. 2 shows a top view of a millimeter-wave widebeam DRA in an embodiment of this disclosure.

FIG. 3 shows simulated reflection coefficient and electric field distribution pattern of a proposed mm-wave widebeam DRA, at 27 GHZ, in an embodiment of this disclosure.

FIGS. 4a-b show simulated radiation pattern of a proposed mm-wave widebeam DRA, at 27 GHZ, in an embodiment of this disclosure.

FIG. 5 shows simulated reflection coefficients of a proposed mm-wave widebeam DRA for different lengths/s of proposed microstrip-coupled slot in an embodiment of this disclosure.

FIGS. 6a-c show principle of wide HPBW in E-plane of a millimeter-wave widebeam DRA, in an embodiment of this disclosure.

FIGS. 7a-b show normalized amplitude patterns of an equivalent magnetic current M with different spacings d.

FIG. 8 shows simulated reflection coefficients and HPBWs of a proposed mm-wave widebeam DRA for different DR heights, in an embodiment of this disclosure.

FIG. 9 shows simulated reflection coefficients and HPBWs of a proposed mm-wave widebeam DRA for different slot lengths, in an embodiment of this disclosure.

FIG. 10 shows simulated electric field distributions of a proposed mm-wave widebeam DRA for different slot lengths, in an embodiment of this disclosure.

FIG. 11 is a flow chart of a design method for a millimeter-wave widebeam DRA according to this disclosure.

FIG. 12 is a schematic diagram of a 1×8 H-plane phased array of this disclosure.

FIG. 13 is a schematic diagram of a 1×8 E-plane phased array of this disclosure;

FIG. 14 shows reflection coefficient and transmission coefficient of simulated elements 1-4 in an E-plane phased array.

FIG. 15 shows reflection coefficient and transmission coefficient of simulated elements 1-4 in an H-plane phased array.

FIGS. 16a-16b are schematic diagrams of a simulated scanning performance of an E-plane phased array at 27 GHz.

FIGS. 17a-17b are schematic diagrams of a simulated scanning performance of an H-plane phased array at 27 GHz.

FIG. 18 is a schematic diagram of a processing model of an E-plane DRA phased array.

FIGS. 19a-19b show a comparison between measured and simulated scanning performance of a proposed mm-wave E-plane phased arrays with and without a feed network.

### DESCRIPTION OF THE PREFERRED EMBODIMENTS

This disclosure provides a millimeter-wave widebeam DRA (Dielectric Resonator Antenna), a wide-angle beam-scanning phased array, a design method for a millimeter-wave widebeam DRA, and a design method for a wide-angle beam-scanning phased array, without requiring any additional parasitic structure(s) and active control circuit(s), while maintaining a compact size, aiming at a technical problem existing in a prior wide-angle beam-scanning phased array, such as a large footprint or a complex structure. The main idea of this disclosure is to set a DR on a ground plane on a top of a dielectric substrate, etch a microstrip-coupled slot on the ground plane which slot is located beneath the dielectric resonator, set a microstrip line on a bottom of the dielectric substrate. The DRA consists of the DR and the microstrip-coupled slot which is located beneath the DR. By arranging dimensions of the microstrip-coupled slot and the dielectric resonator to make the resonance frequency of the unexcitable TE₁₁₂ mode of the dielectric resonator match the resonance frequency of the microstrip-coupled slot, the DR shows a quasi-TE₁₁₂ mode field distribution in its interior, which radiates as an equivalent magnetic current parallel to the ground plane, thus realizing widebeam performance in E-plane and H-plane. Moreover, an E-plane and an H-plane linear phased array can be formed by arraying a plurality of designed millimeter-wave widebeam DRAs at equal intervals in a straight line according to a preset spacing, wherein the linear phased array shows a scan range of wide-angle. Furthermore, the millimeter-wave widebeam DRA and wide-angle beam-scanning phased array of this disclosure requires not any additional parasitic structure(s) and active control circuit(s), thus having a compact dimension.

In order to make the purpose, technical solution, and advantages of this disclosure more apparent, the following refers to the attached drawings to describe in detail the exemplary embodiments according to this disclosure. Obviously, the described embodiments are only some of the embodiments of this disclosure, not all of them. It should be understood that this disclosure is not limited by the exemplary embodiments described here. It should be understood that this disclosure can be implemented in different forms and should not be limited to the embodiments proposed here. On the contrary, providing these embodiments makes the disclosure thorough and complete, and fully conveys the scope of this disclosure to those skilled in the art. It should be understood that the embodiments of this disclosure and the specific features in the embodiments are detailed descriptions of the technical solutions of the present application, rather than limitations of the technical solutions of the present application. In the absence of conflict, the embodiments of this disclosure and the technical features in the embodiments may be combined with each other.

### Embodiment 1

The structure and performance of a specific embodiment of a millimeter-wave widebeam DRA are introduced below.

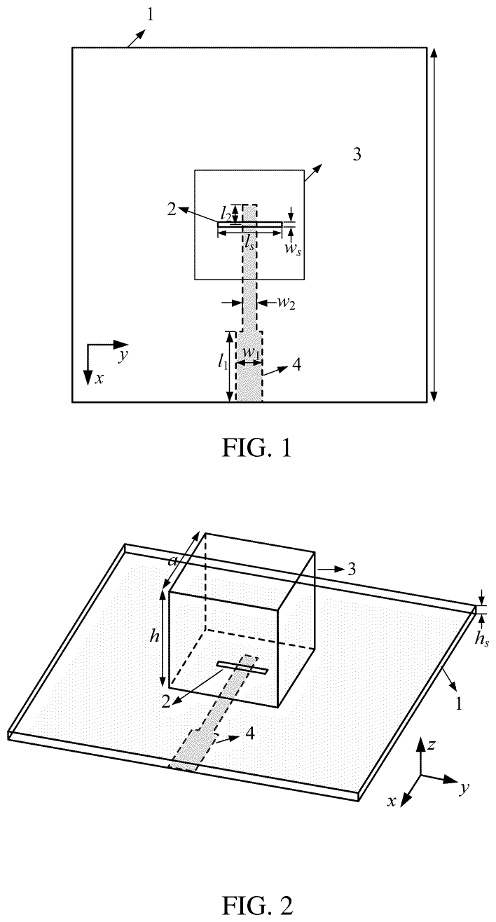

As shown in FIG. 1-2, a perspective view and a top view are shown for a millimeter-wave widebeam DRA according to a specific embodiment of this disclosure. In the figures, 1 represents a printed circuit board (PCB), 2 represents a slot, 3 represents a DR, and 4 represents a microstrip line. FIG. 1 is a typical slot-coupled fed DRA. As shown in the figure, a square DR with a side length a, a height h, and a dielectric constant dielectric constant εᵣ₁ is fed by a microstrip-coupled rectangular slot. It is understandable that, in theory, a cross section of the DR can also be a rectangle, but in this embodiment, a square is chosen for reducing one design parameter and making parameter adjustment easier. The slot with a dimension of lₛ×wₛ is etched on an upper surface of a square printed circuit board (PCB) with a thickness hₛ and is with a dielectric constant εᵣ₂, and is further excited by a 50 Ohm microstrip line that is printed on a lower surface of the PCB. The slot is centrally located beneath the DR. Here, the so-called beneath specifically means that a center of the slot coincides with a projection of a center of the DR, and the slot is parallel to one pair of square side edges of the DR and vertical to the other pair of square side edges. Here, for good impedance matching, a stepped microstrip line is applied. The stepped microstrip line refers to a microstrip line that is l-shaped as a whole, but divided into two sections with different widths. For example, in this embodiment, the microstrip line is l-shaped as a whole, and vertical to the microstrip-coupled slot; wherein the microstrip line extends from a side edge of the dielectric substrate along a projection of a perpendicular midline of the microstrip-coupled slot at a width w₁ for a length l₁, and then still extends along the projection of the perpendicular midline of the microstrip-coupled slot at a reduced width w₂ and beyond the projection of the perpendicular midline of the microstrip-coupled slot for a length l₂; wherein the side edge of the dielectric substrate is parallel to the microstrip-coupled slot.

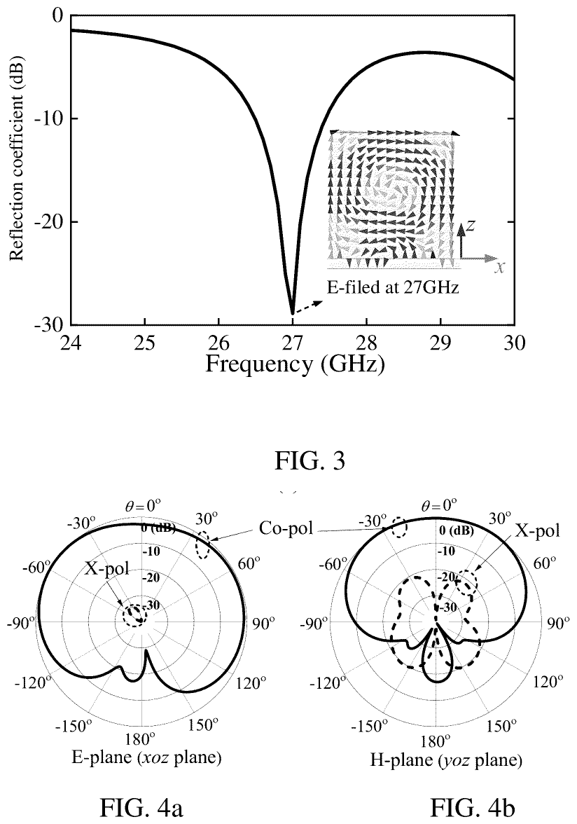

The parameter values of DRA in this embodiment are as follows (unit: mm): εᵣ₁=10.2, εᵣ₂=2.2, a=3.0, h=3.1, hₛ=0.254, g=10, lₛ=1.8, wₛ=0.18, l₁=3, l₂=0.9, w₁=0.74, and w₂=0.4. The simulated reflection coefficient and radiation pattern of the proposed widebeam DRA are shown in FIGS. 3 and 4a-b. The electric field distribution at 27 GHz is also given in FIG. 3. It can be clearly seen that there is a resonance at 27 GHz, giving a-10 dB impedance bandwidth of 3.7% ranging from 26.5 to 27.5 GHz. In addition, FIG. 4a and FIG. 4b represent radiation patterns of the E-plane and the H-plane, respectively. It can be seen that the radiation patterns of the E-plane and the H-plane both have widebeam characteristics, and their HPBWs are 228° and 132°, respectively. A low cross-polarization level can also be observed in both planes, which is lower than −20 dB near a boresight direction.

The operating mode of the proposed millimeter-wave widebeam DRA of this embodiment is introduced below.

Before explaining the generation mechanism of wide HPBWs, the operating mode of the proposed mm-wave DRA is studied. With reference to the inset of FIG. 3, which shows the electric field distribution inside the DR at 27 GHZ, the field pattern forms a ring shape in an xoz plane, which is very similar to that of a TE_{112(y)} mode of DRA. However, notably, this resonance is not caused by the DRA TE_{112(y)} mode but originates from a resonant mode of the slot on the ground plane. The detailed reasons are given as follows. First, when the slot is centrally located beneath the DRA, a TE_{pqr} mode of DRA can be excited only if all of indices p, q, and r are odd numbers. In other words, the modes with even indices (e.g., the TE_{112(y)} mode) cannot be excited effectively due to a restriction of boundary condition. Moreover, referring to FIG. 5, which shows reflection coefficients of a proposed DRA for different slot lengths lₛ, it can be observed that as the slot length Is increases, resonance frequencies of the DRA TE_{111(y)} mode and TE_{113(y)} mode change slightly, but that of the operating mode in bands of interest shifts downward considerably. Obviously, if the operating mode is the DRA TE_{112(y)} mode, its resonance frequency should be insensitive to the change of the slot length lₛ, just like TE_{111(y)} and TE_{113(y)} modes, but this is not the case, verifying that the operating mode is caused by the resonance of the slot rather than the DRA.

Now, why the ring-shaped electric field of TE₁₁₂ mode can exist in the DR even though there is a ground plane at its bottom. With reference to FIG. 3, at the bottom of DR, the electric field close to the coupling slot is very strong due to coupling energy from a microstrip feed line and such electric field presents a shape of “∩,” while the electric field at other place (away from the coupling slot but close to the ground plane) is vertical to the ground plane and rather weak. As a result, this field distribution not strictly corresponds to but is very close to the field distribution of TE₁₁₂ mode, and hence, it is called quasi-TE₁₁₂ mode in this disclosure. Also, such field distribution does not conflict with the boundary condition of the surface of ideal conductor (ground plane), and therefore, it can be supported by the proposed DRA.

The principle of wide HPBWs is discussed.

As discussed above, although the proposed antenna operates in the resonant mode of the coupling slot, the field inside the DR presents the pattern of TE_{112(y)} mode since its resonance frequency (26.6 GHZ, obtained by the radar cross section (RCS) analysis method) happens to match with the operating frequency of the DR-loaded slot mode. In this case, the radiation characteristic of the antenna mainly depends on the property of the TE_{112(y)} mode of DRA. This is also the reason why we still call the antenna DRA.

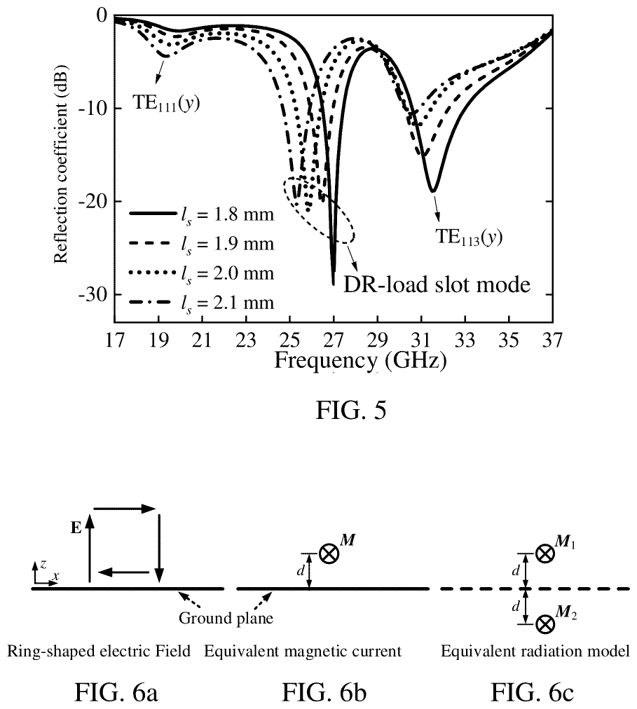

According to the ring-shaped electric field distribution shown in FIG. 3, FIGS. 6a-6c intuitively explain the principle of the wide HPBW in the E-plane. As illustrated, such ring-shaped field distribution of DRA in FIG. 6a can be equivalent to a magnetic current M in FIG. 6b that is parallel to the ground plane, with a spacing of d. Furthermore, according to the image theory, it can be regarded as two magnetic currents (M₁ and M₂) with the same direction in FIG. 6c. In addition, due to the small spacing between M₁ and M₂, their radiation can cover the entire upper half-space ranging from the boresight direction to an endfire direction, and accordingly, the wide HPBW in E-plane is obtained.

The HPBW in the H-plane (132°) is not as wide as that in the E-plane (228°) but is still much wider than the typical beamwidth (˜90°) of DRA. This enhancement is also attributed to an appropriate value of the spacing d. Specifically, the E-plane and H-plane normalized amplitude patterns (F_{E(θ)} and F_{H(θ)}) of the equivalent magnetic current in FIG. 6c can be expressed as follows:

$${F}_{E} ( θ ) = \vert cos ( kd cos ( θ ) ) \vert \qquad ( 1 )$$

$${F}_{H} ( θ ) = \vert cos ( kd cos ( θ ) ) \vert \times \vert cos ( θ ) \vert . \qquad ( 2 )$$

Wherein, d represents the spacing between the magnetic current M and the ground plane, and k represents the wave number, θ represents an azimuth angle.

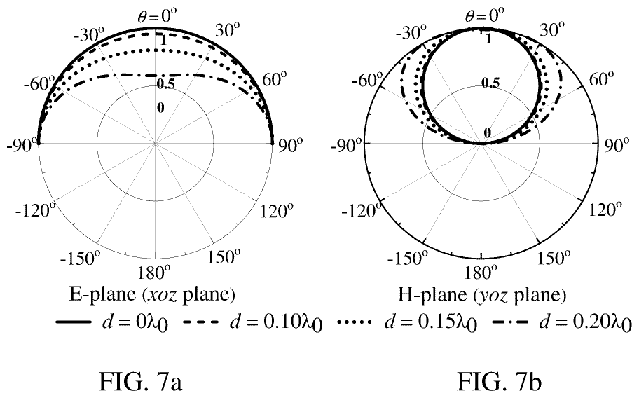

According to equation (1) and (2), FIGS. 7a-7b show radiation patterns for different spacings d, in which, FIG. 7a represents E-plane, FIG. 7b represents H-plane. It can be seen that the E-plane pattern always features a broad HPBW, when the spacing d is small, although the radiation intensity near the boresight direction decreases gradually with the increase of the spacing d. On the other hand, for the H-plane pattern, as the spacing d increases, a radiation intensity near ±60° enhances and thus also presents a widebeam pattern. Consequently, in our design, the widebeam E-plane and H-plane patterns can be achieved simultaneously (see FIGS. 4a-4b) by properly designing the spacing between the equivalent magnetic current M and the ground plane, that is, the dimension of DRA.

It should be mentioned that the proposed DRA presents the ring-shaped electric field distribution of a quasi-TE₁₁₂ mode within a wide frequency band of 24.7-28.8 GHz (15.3%), thus maintaining a widebeam radiation property in the entire frequency band.

### Embodiment 2

This embodiment specifically introduces a design method for a millimeter-wave widebeam DRA in embodiment 1. Before introducing the method of this embodiment, a research process of DRA parameters of the embodiment 1 is first introduced.

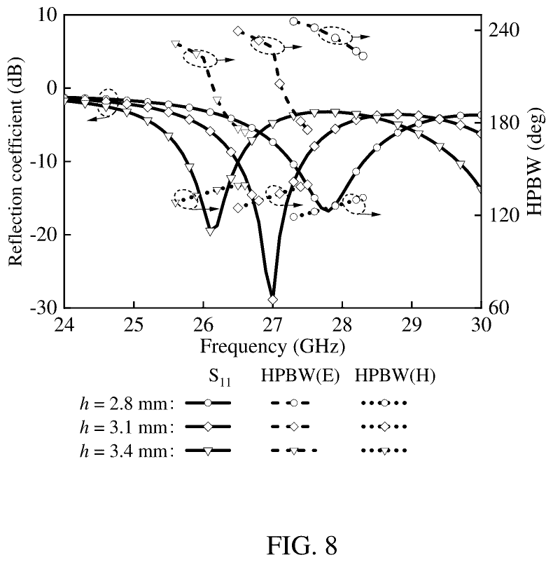

As analyzed above, the DR plays a very important role in forming the equivalent magnetic current and thus influences the antenna performance significantly. Therefore, here, the effects of DR dimension are investigated. FIG. 8 shows simulated reflection coefficients and HPBWs of the proposed millimeter-wave widebeam DRA for different DR heights h. It can be seen that the DR-loaded slot mode is sensitive to the variation of DR height h, and its resonance frequency shifts downward from 27.8 to 26.1 GHZ, when the DR height h increases from 2.8 mm to 3.4 mm, which is reasonable considering the loading effect of DR. As an unexcitable TE₁₁₂ mode of the DRA also shifts downward with the increase of the DR height h, the resonance frequencies of the two modes (i.e., the DR-loaded slot mode and the DRA TE₁₁₂ mode) still match with each other and thus can always provide radiation patterns of widebeam E-plane and H-plane. In addition, it is worth mentioning that in all three cases, the HPBW of the E-plane decreases with the increase of frequency, while that of the H-plane increases, showing an opposite trend. This is because, within a passband, the spacing d (in terms of an electrical length) between the equivalent magnetic current and the ground plane increases with the frequency, thus offering a wider H-plane radiation pattern at a higher frequency according to FIG. 7b. Admittedly, the change in the spacing d is slight, and therefore, widebeam patterns of the millimeter-wave widebeam DRA in both the E-plane and H-plane can be obtained throughout the passband, wherein HPBW of the E-plane is over 180° and HPBW of the H-plane is about 120°, respectively. Due to the same reason, a similar phenomenon can be observed, when a side length a of the DR changes. It can be seen that, the change of a significantly influences the resonance frequency of the DR-loaded slot mode but rarely affects the widebeam characteristics of both E-plane and H-plane in the passband.

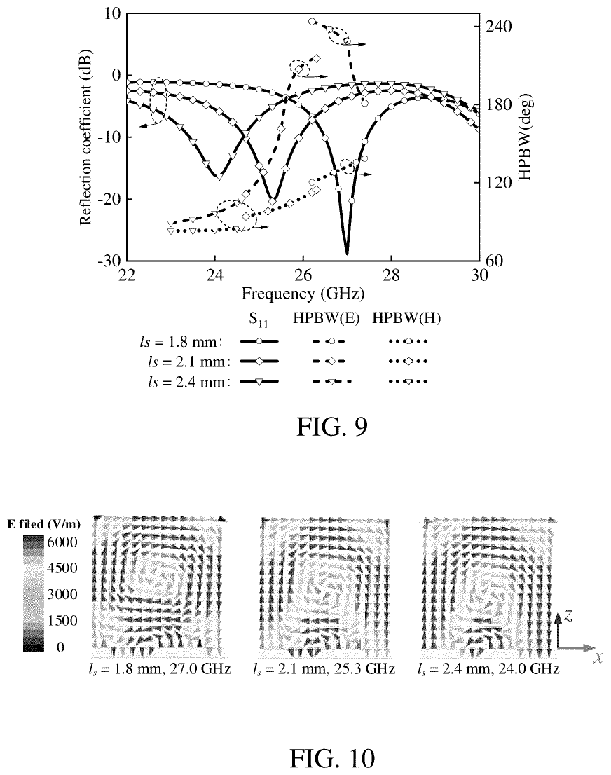

Besides the dimension of the DR, the dimension of the coupling slot also affects the operating DR-loaded slot mode and antenna performance. FIG. 9 shows simulated reflection coefficients and HPBWs of the proposed DRA for different slot lengths, with a fixed dimension of the DR. As shown, when the slot length Is increases from 1.8 to 2.4 mm, the resonance frequency of the DR-loaded slot mode shifts downward from 27.0 to 24.0 GHz as expected. In addition, the HPBWs of both the E-plane and H-plane decrease significantly as the resonant mode moves downward, and they are narrowed to about 95° and 83°, respectively, when the resonance frequency drops to 24.0 GHZ. This is due to the fact that in these three cases, the resonance frequency of the TE₁₁₂ mode of DR remains almost unchanged. When lₛ=2.4 mm, the slot mode becomes far away from the TE₁₁₂ mode but close to the TEm mode. This process can be clearly observed in FIG. 10, which shows the evolution of the electric field distribution inside DR. It can be found that the longer the slot length is, the more similar its field distribution is to that of the TEm mode, therefore giving narrow-beam radiation patterns with typical HPBWs in both the E-plane and H-plane. These results indicate again that for wide-HPBW patterns, it is necessary to set an appropriate slot length to make the operating slot mode match the TE₁₁₂ mode of the DR.

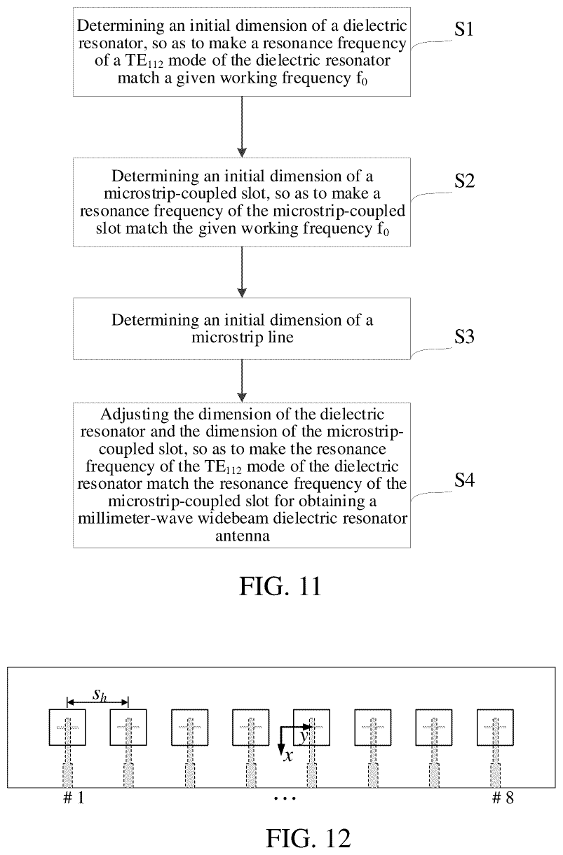

Based on the above analysis and detailed parameter research, under a given operating frequency f₀, in addition to the above-mentioned design method for widebeam DRA, reference to FIG. 11, a design method for a millimeter-wave widebeam dielectric resonator antenna in this disclosure specifically includes follows.

Design step for initial dimension of dielectric resonator S1: Determine an initial dimension of the DR, so as to make a resonance frequency of a TE₁₁₂ mode of the DR match the given working frequency f₀.

Specifically, design the dielectric resonator to have a square cross-section, wherein an initial side length a and an initial height h of the dielectric resonator are both set as a=h=0.27λ₀, wherein λ₀ represents a free-space wavelength of electromagnetic wave at the given working frequency f₀.

Design step for initial dimension of microstrip-coupled slot S: determine an initial dimension of the microstrip-coupled slot, so as to make a resonance frequency of the microstrip-coupled slot match the given working frequency f₀.

Specifically, design, on a ground plane of a dielectric substrate, the microstrip-coupled slot which is centrally located beneath the dielectric resonator; wherein an initial length lₛ of the microstrip-coupled slot is set as lₛ−0.5λ₁, an initial width wₛ of the microstrip-coupled slot is set as wₛ−0.05λ_{g1}, wherein λ_{g1} represents a guided wavelength of electromagnetic wave in the dielectric resonator at the given working frequency f₀.

Design step for initial dimension of microstrip line S3: Design a stepped microstrip line at a bottom of the dielectric substrate and determine an initial dimension of the stepped microstrip line.

Specifically, the initial dimension of the stepped microstrip line is as follows: l₁=0.25λ_{hg2}, w₁=0.10λ_{g2}, l₂=0.12λ₂, w₂=0.06λ_{g2}, where λ_{g2} represents a guided wavelength of electromagnetic wave in the dielectric substrate at the given working frequency f₀.

Adjusting step for dimensions: adjust a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna, and adjust the dimension of the stepped microstrip line for impedance matching.

Specifically, observe whether an electric field distribution inside the dielectric resonator presents a ring-shaped electric field distribution of a quasi-TE₁₁₂ mode; and determine that a resonance frequency of the TE₁₁₂ mode of the dielectric resonator antenna matches a resonance frequency of a slot mode, when the electric field distribution inside the dielectric resonator matches the ring-shaped electric field distribution of the quasi-TE₁₁₂ mode.

It should be noted that the purpose of the above design method is to determine the parameters of DRA. After the parameters are obtained, the actual DRA can be made according to the parameters. Therefore, it can be understood that the initial dimension, size adjustment and effect evaluation mentioned in the above method are all based on simulation.

### Embodiment 3

This embodiment further proposes a design method for a wide-angle beam-scanning phased array based on the embodiment 2, and specifically includes follows.

First, millimeter-wave widebeam DRAs are designed based on the method described in Example 2.

Then, array a plurality of designed millimeter-wave widebeam DRAs at equal intervals in a straight line according to a preset spacing to form a linear phased array; wherein the preset spacing is 0.47λ₀, wherein λ₀ represents a free-space wavelength of electromagnetic wave at the given working frequency f₀.

Finaly, tune the spacing between the designed millimeter-wave widebeam DRAs, the adjusted dimension of the DR, and the adjusted dimension of the microstrip-coupled slot, and the adjusted dimension of the microstrip line, so as to obtain the wide-angle beam-scanning phased array.

### Embodiment 4

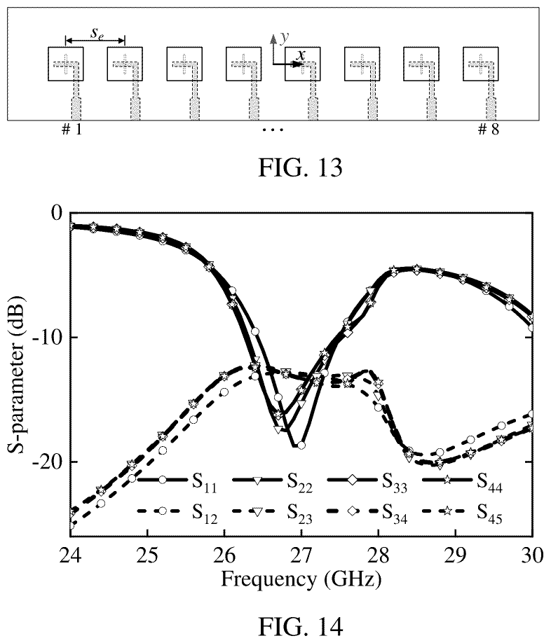

This embodiment mainly introduces an eight-element E-plane phased array and an eight-element H-plane phased array constructed based on the method of the above-mentioned embodiment 3, as shown in FIGS. 12-13.

As shown in FIG. 12, the linear phased array is specifically an H-plane linear phased array, and a length direction of the microstrip-coupled slot is parallel to an arraying direction of the plurality of DRAs. The microstrip line is l-shaped as a whole, and vertical to the microstrip-coupled slot; wherein the microstrip line extends from a side edge of a dielectric substrate along a projection of a perpendicular midline of the microstrip-coupled slot at a width w₁ for a length l₁, and then still extends along the projection of the perpendicular midline of the microstrip-coupled slot at a reduced width w₂ and beyond the projection of the perpendicular midline of the microstrip-coupled slot for a length l₂; wherein the side edge of the dielectric substrate is parallel to the microstrip-coupled slot.

As shown in FIG. 13, the linear phased array is specifically an E-plane linear phased array, and a length direction of the microstrip-coupled slot is vertical to an arraying direction of the plurality of DRAs. Here, in order to feed the DRA of the E-plane phased array, the microstrip line is changed from a “1” shape to a “7” shape, which has almost no effect on the performance of the DRA unit and the phased array.

Specifically, the microstrip line deviates from the microstrip-coupled slot and extends from a side edge of a dielectric substrate along the length direction of the microstrip-coupled slot at a width wi for a length l₁, then still extends along the length direction of the microstrip-coupled slot at a reduced width w₂ to a projection of a perpendicular midline of the microstrip-coupled slot, and then turns for 90° to extend along the projection of the perpendicular midline of the microstrip-coupled slot at the reduced width w₂ and beyond the projection of the perpendicular midline of the microstrip-coupled slot for a length l₂; wherein the side edge of the dielectric substrate is vertical to the microstrip-coupled slot.

It should be noted that in order to obtain the best array performance, the key parameters of each array were slightly adjusted and listed in Table 1. Notably, the element spacings of the two arrays are the same, given by 5.2 mm (0.47λ₀).

TABLE 1
KEY DIMENSIONS OF THE PROPOSED mm-WAVE E-PLANE
AND H-PLANE PHASED ARRAYS (UNIT: mm)

| Parameter | a | h | lₛ | wₛ | sₑ | sₕ |
|---|---|---|---|---|---|---|
| E-plane array | 3.20 | 3.10 | 1.75 | 0.15 | 5.20 | / |
| H-plane array | 3.25 | 3.00 | 1.78 | 0.15 | / | 5.20 |

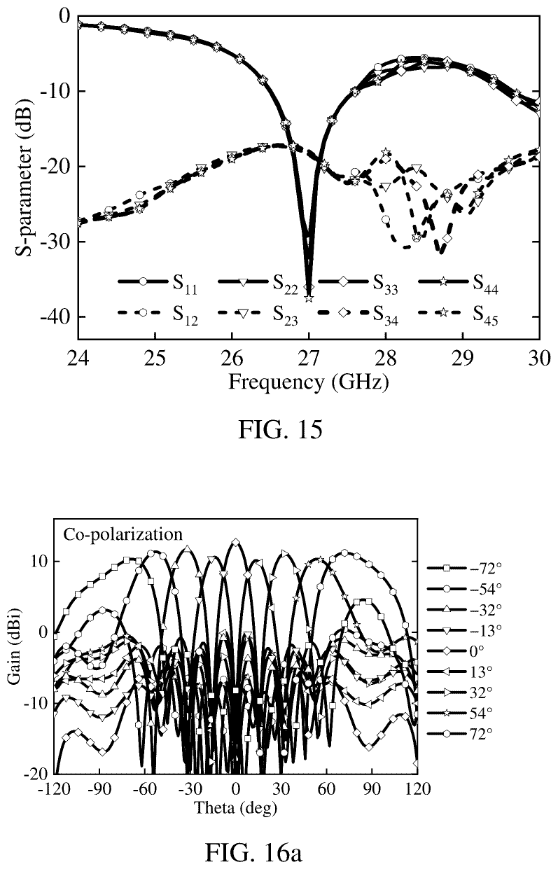

FIG. 14 shows simulated reflection coefficients and transmission coefficients between adjacent elements of the proposed mm-wave E-plane phased array. As the transmission coefficients between nonadjacent elements are not given because they are at least 5 dB lower than that between adjacent elements, they have negligible influence on the beam-scanning performance of the phased array. Here, due to the symmetry of the array structure, only the relevant results of elements 1-4 are presented for the sake of clarity. It can be observed that the reflection coefficients of these four elements are almost the same, showing good impedance matching and giving an overlapping −10 dB impedance bandwidth of 4.1% (26.4-27.5 GHZ). The transmission coefficients between adjacent elements are also at the same level, which is about 14 dB within the passband. FIG. 15 shows the simulated results of the proposed H-plane phased array. Again, the reflection coefficient of each element and the transmission coefficient between every adjacent elements are nearly the same. The overlapping −10 dB impedance bandwidth is given by 4.1% ranging from 26.5 to 27.6 GHZ, and the transmission coefficient between adjacent elements is over 17.1 dB within the passband.

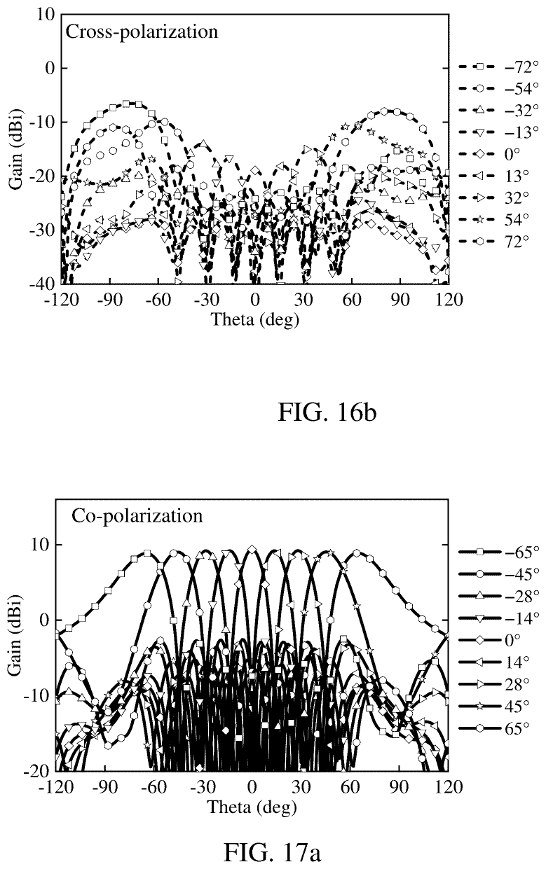

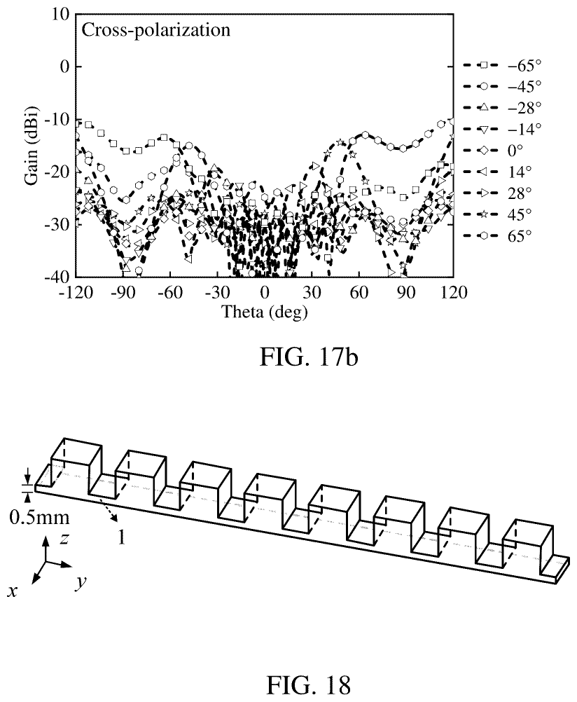

FIGS. 16a-17b show simulated scanning performance of the two proposed phased arrays at 27 GHz. As illustrated, since the HPBW of E-plane is wider than that of H-plane for the proposed DRA element, the scanning range of the corresponding E-plane phased array is naturally wider than that of the H-plane counterpart. Specifically, referring to FIG. 16a-16b, FIG. 16a represents co-polarization, FIG. 16b represents cross-polarization. The main beam of the E-plane phased array can scan from −72° to +72°, giving a gain fluctuation of 2.5 dB (varying between 10.1 and 12.6 dBi). While for the H-plane phased array, referring to FIGS. 17a-17b, FIG. 17a represents co-polarization, FIG. 17b represents cross-polarization. The main beam of the H-plane phased array can scan from −65° to +65°, giving a very low gain fluctuation of only 0.5 dB (varying between 8.9 and 9.4 dBi) and the maximum side lobe level (SLL) is less than −9.3 dB over the concerned scanning range. It is noted that the beam gain of the H-plane phased array is relatively lower than that of the E-plane array although these two phased arrays are constructed by nearly the same DRA element. This is because, for the H-plane phased array, the E-plane beamwidth is still over 200°, while the H-plane beamwidth of the E-plane phased array is narrowed to about 100°, leading to an enhanced beam gain. In addition, both arrays exhibit high polarization purity. Within the entire scanning range, the co-polarized field is higher than the cross-polarized field by at least 16.6 dB in the E-plane phased array and at least 21.9 dB in the H-plane phased array.

For the simulated 1×8 mm-wave E-plane linear phased array, we fabricated and tested its physical prototype to verify its feasibility. Here, in order to avoid introducing positioning error, eight small DRA elements are not processed separately but are processed together by introducing a thin support dielectric slab (thickness: 0.5 mm) at the bottom, in the way of integrated processing, as shown in FIG. 18. Three one-input-eight-output feeding networks (FNs) with fixed phase differences of 0°, 90°, and 165° are designed, fabricated, and connected to the proposed E-plane phased array to verify three beam-scanning states of 0°, 32°, and 72°, respectively. Notably, a very thin layer of instant glue is utilized to cement the integrated DRA array and the FN, which has a negligible effect on the array performance.

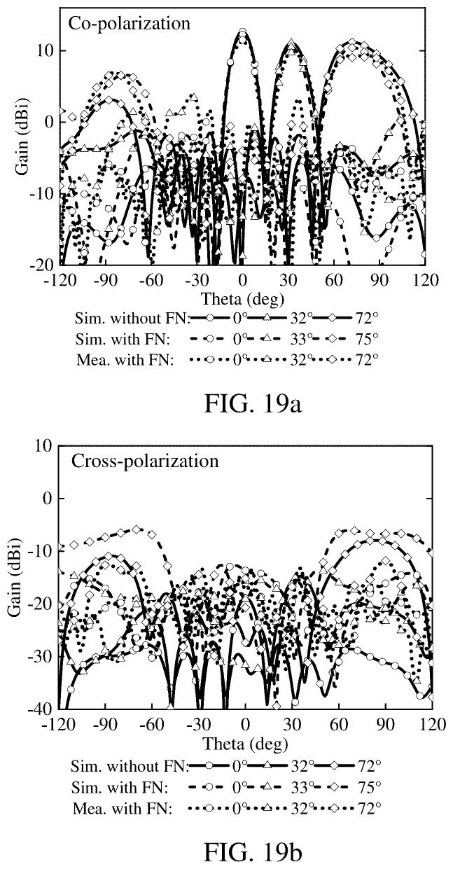

FIGS. 19a-19b show the measured and simulated scanning performance of the prototype with FN, and the simulated result of the proposed E-plane phased array without FN [i.e., FIG. 13] is also included in the figure for comparison. Notably, it is found in our measurement that due to the permittivity error and processing error of DRA, the working frequency of the prototype moves downward to 26.2 GHZ, and therefore, the corresponding measured results at 26.2 GHz are compared with the simulated results at 27 GHz in FIG. 19a-19b. Referring to FIGS. 19a-19b, FIG. 19a represents co-polarization, FIG. 19b represents cross-polarization. As illustrated, at all the three different scanning angles, the beam shape and cross-polarization level of the prototype with the feed network have a good agreement with the simulated results of the phased array with and without the feed network. The specific information about scanning performance is listed in Table 2.

TABLE 2
SCANNING PERFORMANCE OF THE
PROPOSED E-PLANE PHASED ARRAY

Scanning angle, beam gain (dBi)

| | | | |
|---|---|---|---|
| Simulation without feeding | 0°, 12.6 | 32°, 11.1 | 72°, 11.2 |
| network at 27 GHz | | | |
| Simulation with feeding | 0°, 12.2 | 32°, 10.5 | 72°, 10.4 |
| network at 27 GHz | | | |
| Measurement with feeding | 0°, 11.5 | 33°, 9.8 | 75°, 9.5 |
| network at 26.2 GHz | | | |

It can be seen that the beam gain of the array with FN is slightly lower than that of the array without FN, which is as expected considering the losses introduced by the FN. In addition, it is observed that the measured results have a small deviation at scanning angles of 32° and 72°. This is also reasonable in light of the unavoidable test error.

Moreover, it is observed that our proposed phased arrays operating in the mm-wave band can obtain a wide beam-scanning range in both the E-plane (−72° to +72°) and H-plane (−65° to +65°). Most importantly, compared with the previous DRA phased arrays, our proposed designs present a small size and the simplest structure due to the novel implementation method of equivalent magnetic current, which eliminates the need to add any parasitic structure and active control circuit.

Unless defined otherwise, all technical and scientific terms used herein have the same meaning as commonly understood by one of ordinary skill in the art to which this invention belongs. The terms used in the description of this disclosure herein are for the purpose of describing specific embodiments only and are not intended to restrict this disclosure.

As used herein, the term “and/or” includes any and all combinations of one or more of the associated listed items.

The embodiments of this disclosure are described above in conjunction with the accompanying drawings, but this disclosure is not limited to the above-mentioned specific implementation modes, which are merely illustrative rather than restrictive. Under the guidance of this disclosure, ordinary technicians in this field can also make many forms without departing from the scope of protection of this disclosure and the claims, all of which are within the protection of this disclosure.

What is claimed is:

1. A design method for a millimeter-wave widebeam dielectric resonator antenna, which is composed of a dielectric resonator and a microstrip-coupled slot which is centrally located beneath the dielectric resonator;
wherein the method comprises:
determining an initial dimension of the dielectric resonator, so as to make a resonance frequency of a TE₁₁₂ mode of the dielectric resonator match a given working frequency f₀;
determining an initial dimension of the microstrip-coupled slot, so as to make a resonance frequency of the microstrip-coupled slot match the given working frequency f₀;
adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna.

2. The design method according to claim 1, wherein, determining an initial dimension of the dielectric resonator, so as to make a resonance frequency of a TE₁₁₂ mode of the dielectric resonator match a given working frequency f₀, comprises:
designing the dielectric resonator to have a square cross-section, wherein an initial side length a and an initial height h of the dielectric resonator are both set as a=h=0.27λ₀, wherein λ₀ represents a free-space wavelength of electromagnetic wave at the given working frequency f₀.

3. The design method according to claim 1, wherein, determining an initial dimension of the microstrip-coupled slot, so as to make a resonance frequency of the microstrip-coupled slot match the given working frequency f₀, comprises: designing, on a ground plane on a top of a dielectric substrate, the microstrip-coupled slot which is centrally located beneath the dielectric resonator; wherein an initial length lₛ of the microstrip-coupled slot is set as lₛ=0.5λ_{g1}, an initial width ws of the microstrip-coupled slot is set as wₛ=0.05λ_{g1}, wherein λ_{g1} represents a guided wavelength of electromagnetic wave in the dielectric resonator at the given working frequency f₀.

4. The design method according to claim 1, wherein, adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna, comprises:
observing whether an electric field distribution inside the dielectric resonator presents a ring-shaped electric field distribution of a quasi-TE₁₁₂ mode;
determining that a resonance frequency of the TE₁₁₂ mode of the dielectric resonator antenna matches a resonance frequency of a slot mode, when the electric field distribution inside the dielectric resonator matches the ring-shaped electric field distribution of the quasi-TE₁₁₂ mode.

5. The design method according to claim 3, wherein, further comprising designing a stepped microstrip line at a bottom of the dielectric substrate.

6. The design method according to claim 5, wherein, adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna, further comprises:
adjusting a dimension of the stepped microstrip line for impedance matching.

7. A design method for a wide-angle beam-scanning phased array, comprising: determining an initial dimension of the dielectric resonator, so as to make a resonance frequency of a TE₁₁₂ mode of the dielectric resonator match a given working frequency f₀;
determining an initial dimension of the microstrip-coupled slot, so as to make a resonance frequency of the microstrip-coupled slot match the given working frequency f₀;
adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining a millimeter-wave widebeam dielectric resonator antenna;
arraying a plurality of designed millimeter-wave widebeam dielectric resonator antennas at equal intervals in a straight line according to a preset spacing to form a linear phased array;
tuning the spacing between the designed millimeter-wave widebeam dielectric resonator antennas, the adjusted dimension of the dielectric resonator, and the adjusted dimension of the microstrip-coupled slot, so as to make the resonance frequency of the TE₁₁₂ mode of the dielectric resonator match the resonance frequency of the microstrip-coupled slot for obtaining the wide-angle beam-scanning phased array.

8. The design method according to claim 7, wherein, determining an initial dimension of the dielectric resonator, so as to make a resonance frequency of a TE₁₁₂ mode of the dielectric resonator match a given working frequency f₀, comprises:
designing the dielectric resonator to have a square cross-section, wherein an initial side length a and an initial height h of the dielectric resonator are both set as a=h=0.27λ₀, wherein λ₀ represents a free-space wavelength of electromagnetic wave at the given working frequency f₀.

9. The design method according to claim 7, wherein, determining an initial dimension of the microstrip-coupled slot, so as to make a resonance frequency of the microstrip-coupled slot match the given working frequency f₀, comprises:
designing, on a ground plane on a top of a dielectric substrate, the microstrip-coupled slot which is centrally located beneath the dielectric resonator; wherein an initial length ls of the microstrip-coupled slot is set as lₛ=0.5λ_{g1}, an initial width ws of the microstrip-coupled slot is set as wₛ=0.05λ_{g1}, wherein λ_{g1} represents a guided wavelength of electromagnetic wave in the dielectric resonator at the given working frequency f₀.

10. The design method according to claim 7, wherein, adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna, comprises:
observing whether an electric field distribution inside the dielectric resonator presents a ring-shaped electric field distribution of a quasi-TE₁₁₂ mode;
determining that a resonance frequency of the TE₁₁₂ mode of the dielectric resonator antenna matches a resonance frequency of a slot mode, when the electric field distribution inside the dielectric resonator matches the ring-shaped electric field distribution of the quasi-TE₁₁₂ mode.

11. The design method according to claim 9, wherein, further comprising designing a stepped microstrip line at a bottom of the dielectric substrate.

12. The design method according to claim 11, wherein, adjusting a dimension of the dielectric resonator and a dimension of the microstrip-coupled slot, so as to make the resonance frequency of the TE₁₁₂ mode of the dielectric resonator match the resonance frequency of the microstrip-coupled slot for obtaining the millimeter-wave widebeam dielectric resonator antenna, further comprises:
adjusting a dimension of the stepped microstrip line for impedance matching.

13. The design method according to claim 7, wherein, the preset spacing is 0.47λ₀, wherein λ₀ represents a free-space wavelength of electromagnetic wave at the given working frequency f₀.

14. The design method according to claim 7, wherein, the linear phased array is an H-plane linear phased array.

15. The design method according to claim 7, wherein, a length direction of the microstrip-coupled slot is parallel to an arraying direction of the plurality of designed millimeter-wave widebeam dielectric resonator antennas; a microstrip line is l-shaped as a whole, and vertical to the microstrip-coupled slot; wherein the microstrip line extends from a side edge of a dielectric substrate along a projection of a perpendicular midline of the microstrip-coupled slot at a width w₁ for a length l₁, and then still extends along the projection of the perpendicular midline of the microstrip-coupled slot at a reduced width w₂ and beyond the projection of the perpendicular midline of the microstrip-coupled slot for a length l₂; wherein the side edge of the dielectric substrate is parallel to the microstrip-coupled slot.

16. The design method according to claim 7, wherein, the linear phased array is an E-plane linear phased array.

17. The design method according to claim 16, wherein, a length direction of the microstrip-coupled slot is vertical to an arraying direction of the plurality of designed millimeter-wave widebeam dielectric resonator antennas; a microstrip line is 7-shaped as a whole; wherein the microstrip line deviates from the microstrip-coupled slot and extends from a side edge of a dielectric substrate along the length direction of the microstrip-coupled slot at a width w₁ for a length l₁, then still extends along the length direction of the microstrip-coupled slot at a reduced width w₂ to a projection of a perpendicular midline of the microstrip-coupled slot, and then turns for 90° to extend along the projection of the perpendicular midline of the microstrip-coupled slot at the reduced width w₂ and beyond the projection of the perpendicular midline of the microstrip-coupled slot for a length l₂; wherein the side edge of the dielectric substrate is vertical to the microstrip-coupled slot.
